(19) United States
(12) Patent Application Publication
(10) Pub. No.: US 2001/0055011 A1
(43) Pub. Date: Dec. 27, 2001

(54) Display controller for applying display effect

(75) Inventors: Masayuki Terao, Tokyo (JP); Hidehiko Okada, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/887,076

(22) Filed: Jun. 25, 2001

(30) Foreign Application Priority Data
Jun. 26, 2000 (JP) 191486/2000

(51) Int. Cl. G09G 5/00

(52) U.S. Cl. 345/204

(57) ABSTRACT

To provide an information processor which, in case a component in which a moving picture is displayed is overlapped by another window, can apply display effect only to a region on which the moving picture is actually displayed.

The information processor comprises a component detector which detects a particular display component located within a window on a screen, a visible region determiner which determines an actually visible region of a region in which the particular display component is to be displayed, and a display effector which applies predetermined display effect to the region.

### BACKGROUND OF THE INVENTION

The present invention relates to a display controller, and more particularly to a display controller, which controls a screen which carries out display in a multi-window system.

Recently, opportunities of viewing a moving picture displayed on a liquid crystal display (an LCD) have been increased. However, when a moving picture is displayed on an LCD, there is a phenomenon that the image is less recognizable compared with a case where such an image is displayed on a CRT display because problems such as insufficient contrast, inaccurate reproduction of colors, and unvivid black color are caused.

Accordingly, in order to solve such a problem, conventionally, the brightness of an image is automatically determined to carry out necessary control of the brightness of a light source and of contrast. In this way, the maximum luminance is increased in case of a bright image while the minimum luminance (black standout) is decreased in case of a dark image.

However, since such conventional control for improving the image quality is applied to all of a region in which a moving picture is to be displayed, there is a problem described in the following.

By the way, as the recent operational environment of a computer, a multi-window environment where a plurality of windows are displayed on a screen and the windows can overlap each other is common, and further, a graphical user interface environment where components such as a title bar and buttons are displayed on a window is common.

Under such a multi-window environment, when a component in which a moving picture is displayed is overlapped by another window and part of the component is hidden behind, it is often the case that a region on which the moving picture is displayed on the screen (a region where the moving picture is visible to a user of the computer) is not equal to a region surrounded by an outer frame of the component in which the moving picture is displayed.

With this state, if the effect of improving the image quality is applied to the whole region surrounded by the outer frame of the component on which the moving picture is displayed, that is, the region where the moving picture is to be displayed, that effect of improving the image quality is applied also to a region where the content of the display is not a moving picture (a region of part of a window overlapping the component in which the moving picture is displayed), which results in lowered image quality of the region where the content of the display is not a moving picture.

This is because the applied effect of improving the image quality is an effect specialized for a moving picture, and not an effect suitable for a region where the content of the display is not a moving picture.

### SUMMARY OF THE INVENTION

Accordingly, an object of the present invention is to provide a display controller, an information processor with a display control function, a display control method, and a computer program which, in case a component in which a moving picture is displayed is overlapped by another window, can apply display effect only to a region in which the moving picture is actually displayed (a region where the moving picture is visible to a user of the computer).

According to an aspect of the present invention, there is provided a display controller comprising: a first element, which controls a display to display a screen provided with a first screen region on which a particular display component is to be displayed and a second screen region overlapping at least part of the first screen region; and a second element, which applies display effect to only a screen region of the first screen region without the second screen region overlapped therewith.

According to other aspect of the present invention, these is provided a information processor comprising: a detector, which detects a particular display component located within a window on a screen; a visible region determiner, which determines an actually visible region of a region in which said particular display component detected by the detector is to be displayed; and a display effector, which applies predetermined display effect to the region detected by the visible region determiner.

According to other aspect of the present invention, these is provided a display control method comprising: a first step of detecting a particular display component located within a window on a screen; a second step of determining an actually visible region of a region in which the detected particular display component is to be displayed; and a third step of applying predetermined display effect to the detected region.

### BRIEF DESCRIPTION OF THE DRAWINGS

These and other objects, features and advantages of the invention will become more apparent from the following detailed description when taken in conjunction with the accompanying drawings, in which:

FIG. 1 is a block diagram for explaining the hardware architecture of an embodiment of the present embodiment;

FIG. 2is a block diagram for explaining the architecture of the embodiment of the present embodiment;

FIG. 3 is a view illustrating an example of a component registration table;

FIG. 4 is a view illustrating an example of a screen;

FIG. 5 is a view illustrating an example of a window location table;

FIG. 6 is a view illustrating an example of a component location table;

FIG. 7 is a view illustrating another example of the screen;

FIG. 8 is a view illustrating an example of an overlap table;

FIG. 9 is a view illustrating another example of the overlap table;

FIG. 10 is a view illustrating still another example of the overlap table;

FIG. 11(a) is a view illustrating example of determination of a visible region by a visible region determiner;

FIG. 11(b) is another view illustrating example of determination of a visible region by a visible region determiner;

FIG. 12 is a view illustrating an example of a visible region management table;

FIG. 13 is a view illustrating still another example of the screen;

FIG. 14 is a view illustrating another example of determination of a visible region by the visible region determiner;

FIG. 15 is a view illustrating another example of the visible region management table;

FIG. 16 is a view illustrating yet another example of the screen;

FIG. 17 is a view illustrating still another example of determination of a visible region by the visible region determiner;

FIG. 18 is a view illustrating still another example of the visible region management table;

FIG. 19 is a flow chart for explaining the operation of an information processor; and

FIG. 20 is a flow chart for explaining the operation of the information processor.

### DESCRIPTION OF THE PREFERRED EMBODIMENT

A preferred embodiment of the present invention will be described in detail below with reference to the accompanying drawings.

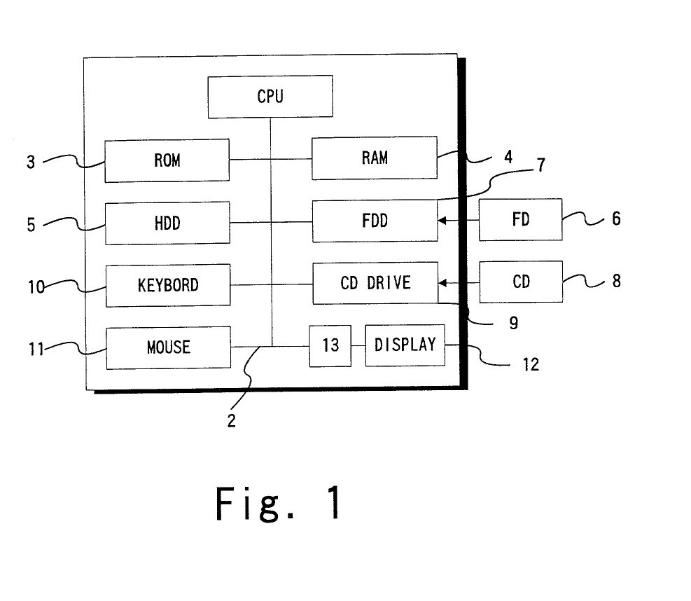

In the embodiment of the present invention, a display control function according to the present invention is applied to an information processor represented by a personal computer. FIG. 1 illustrates the hardware architecture of the information processor of the present embodiment.

Referring to FIG. 1, the information processor of the present embodiment comprises a CPU1 for controlling the whole apparatus. The CPU (Central Processing Unit) 1 is connected through a bus 2 to hardware such as a ROM (Read Only Memory) 3, a RAM (Random Access Memory) 4, an HDD (Hard Disc Drive) 5, an FDD (Floppy Disc Drive) 7 into which an FD (Floppy Disc) is replaceably loaded, a CD (Compact Disc) drive 9 into which a CD 8 is replaceably loaded, a keyboard 10, a mouse 11, a display 12, a display controller 13 and the like. Further, the information processor is capable of displaying image on the display in a multi-window. The display 12 is, for example, an LCD, a CRT display, a plasma display, or the like, is not specifically limited, and controlled by the display controller 13.

A display control program is stored in the FD 6 or in the CD 8. The CPU 1 reads and executes the program to carry out display control according to the present invention, which is described in the following. Of course, the recording medium in which the display control program is stored is not limited to an FD or a CD, and the display control program may be stored in advance in the HDD 5, the RAM 4, or the ROM 3. Further, an LSI with a display control function according to the present invention may be provided in the information processor.

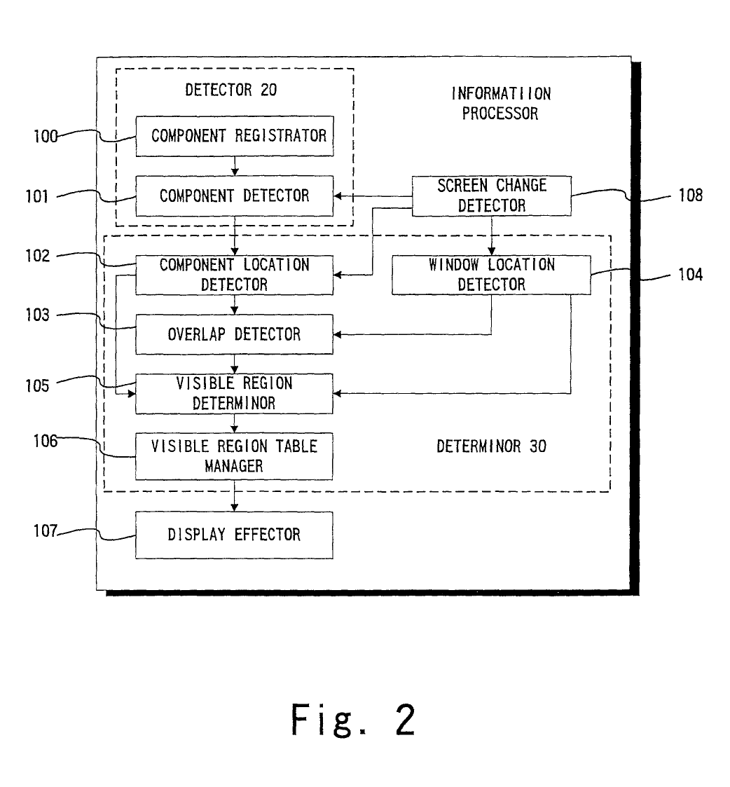

When the CPU 1 reads the display control program from the recording medium and executes the display control program, the information processor is logically provided with means illustrated in FIG. 2.

Referring to FIG. 2, the information processor includes a detector 20 including a component registrator 100 and a component detector 101; a visible region determinor 30 including a component location detector 102, an overlap detector 103, a window location detector 104, a visible region determinor 105, and a visible region table manager 106; display effector 107; and a screen change detector 108.

In the following description of the embodiment, a component means a portion, which displays a moving picture in a window or an inside-window. However, the source displayed on the portion is not limited to a moving picture.

The component registrator 100 is, for example, a table provided in a predetermined storage region of the information processor (hereinafter referred to as a component registration table), where the names of the kinds of components and the names of their parent windows, that is, the windows where the respective components are located, are registered correspondingly to each other.

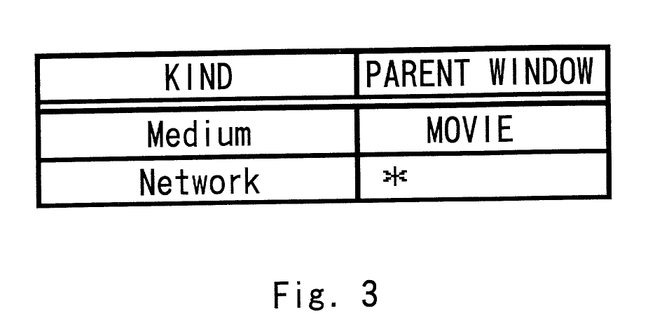

FIG. 3 illustrates an example of the component registration table. Referring to FIG. 3, the name of the kind of a component “Medium” and the name of its parent window “MOVIE” are registered correspondingly to each other. Here, in the table, the name of the kind of a component “¹Network” corresponds to the name of its parent window “*”. The identifier “*” means that the parent window is arbitrary. In this example, a moving picture reproduced from a recording medium is categorized into “Medium”. On the other hand, a moving picture played thorough a communication network is categorized into “Network”.

The component detector 101 detects components on a screen which are registered in advance in the component registration table by referring to the table.

In case the component registration table is structured as illustrated in FIG. 3, now, it is assumed that a window titled as “MOVIE” is displayed on the screen and a component the name of the kind of which is “Medium” is located in that window. Then, the component detector 101 detects the component. If, now, a component the name of the kind of which is “Network” is located in an arbitrary window on the screen, the component detector 101 also detects the component.

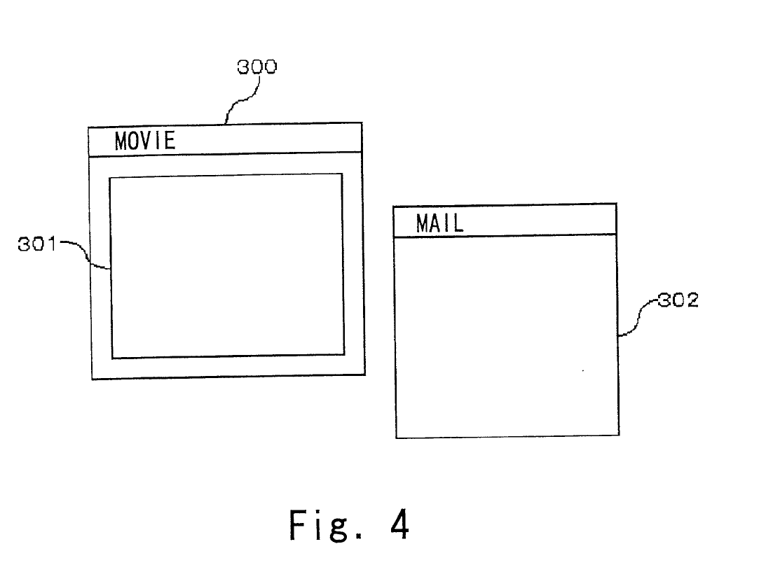

More specifically, in case, for example, a window 300 titled as “MOVIE” and a window 302 titled as “MAIL” are displayed on the present screen (the outer frames of the screen and similar screens hereinafter are not shown) as illustrated in FIG. 4, if the name of the kind of a component 301 located in the window 300 is “Medium”, the component detector 101 detects it. If the name of the kind of the component 301 is “Network”, the component detector 101 also detects it.

The window location detector 104 detects the locations of the windows now displayed on the screen and z-orders of the windows.

In the embodiment, a lateral direction of the screen is an x-axis, a longitudinal direction of the screen is a y-axis, an uppermost left end point is an origin (x, y)=(0, 0), a direction to the right is a positive direction of the x-axis, and a downward direction is a positive direction of the y-axis. In case the size of the whole screen is 1024 dots x 768 dots, the coordinate values of a lowermost right end point of the screen are (1024, 768). In the embodiment, as the location of a window, the window location detector 104 detects coordinate values (x, y) of an uppermost left end point and coordinate values (x, y) of a lowermost right end point of the window. It is to be noted that the way of describing the location of a window is not limited thereto, and may be anything as far as it describes the location of the window on the screen.

A z-orders of a window is a value describing whether the window is in front of or at the back of other windows. As the z-order of a window becomes smaller, it follows that the window stands more forward, that is, stands nearer to side of a user viewing the screen. Therefore, suppose that the z-order of a window W1 is z1 while the z-order of a window W2 is z2 and z1<z2, it follows that the window W1 stands more forward than (is in front of) the window W2.

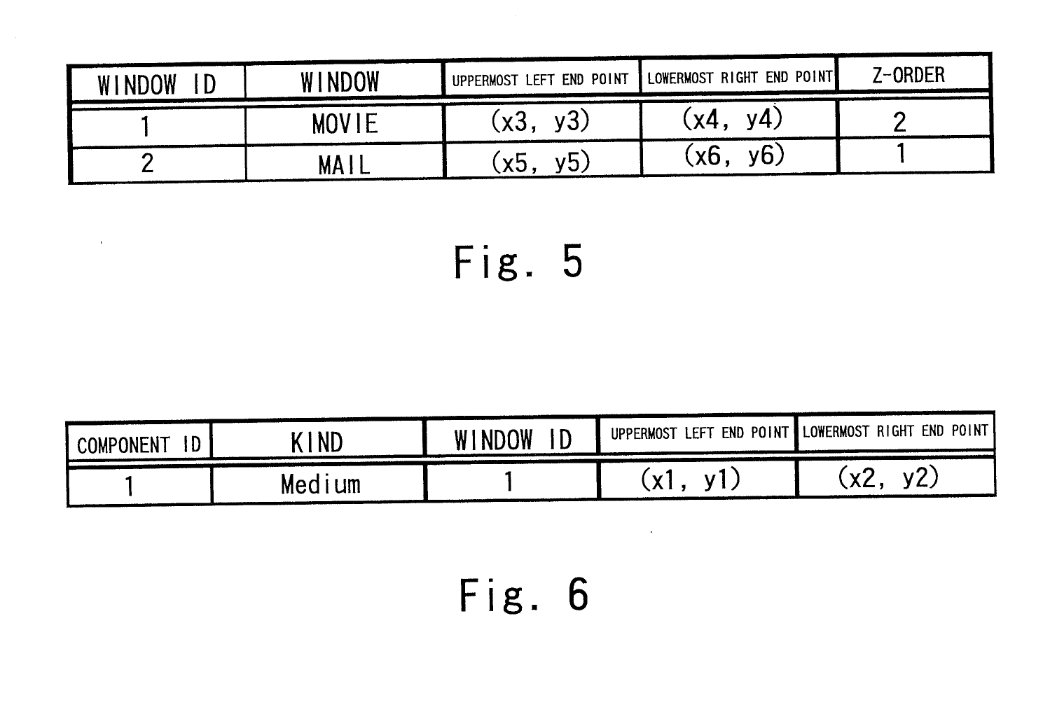

More specifically, in case the present screen is as illustrated in FIG. 4, the window location detector 104 detects the locations of the windows and z-orders of the windows, and then creates a data table, which is, for example, as illustrated in FIG. 5 (hereinafter referred to as a window location table) in a predetermined storage region of the information processor.

Referring to FIG. 5, the coordinate values of an uppermost left end point, the coordinate values of a lowermost right end point, and the z-order of the window 300 are detected to be (x3, y3), (x4, y4), and “2”, respectively, while the coordinate values of an uppermost left endpoint, the coordinate values of a lowermost right end point, and the z-order of the window 301 are detected to be (x5, y5), (x6, y6), and “1”, respectively, wherein x3 to x6 are positive integers which are zero or larger and the lateral size of the screen or smaller, and y3 to y6 are positive integers which are zero or larger and the longitudinal size of the screen or smaller.

An ID is allotted to each of the detected windows for identifying the window. An arbitrary ID may be allotted every time a window is detected, or, alternatively, in case there is no possibility that windows having the same name are opened at the same time, the IDs may be allotted in advance with regard to the respective window names.

The component location detector 102 detects the location of the component detected by the component detector 101. The location of the detected component is described by coordinate values (x, y) of the uppermost left end point and coordinate values (x, y) of the lowermost right end point of the component. Similarly to the detection of the location of a window described in the above, the way of describing the location of a component is not limited thereto.

More specifically, in the example of the screen illustrated in FIG. 4, if the name of the kind of the component 301 is “Medium”, the location detector 102 detects the location of the component 301 detected in the preceding stage by the component detector 101 as the coordinate values of the uppermost left end point and the coordinate values of the lowermost right end point of the component 301, and, creates a data table, which is, for example, as illustrated in FIG. 6 (hereinafter referred to as a component location table) in a predetermined storage region of the information processor.

Referring to FIG. 6, in the component location table, component IDs uniquely allotted, similarly to the above-described window IDs, the names of the kinds of components, the IDs of the windows which include the components (window IDs), and the locations ((x1, y1), (x2, y2)) of the detected components are registered correspondingly to one another.

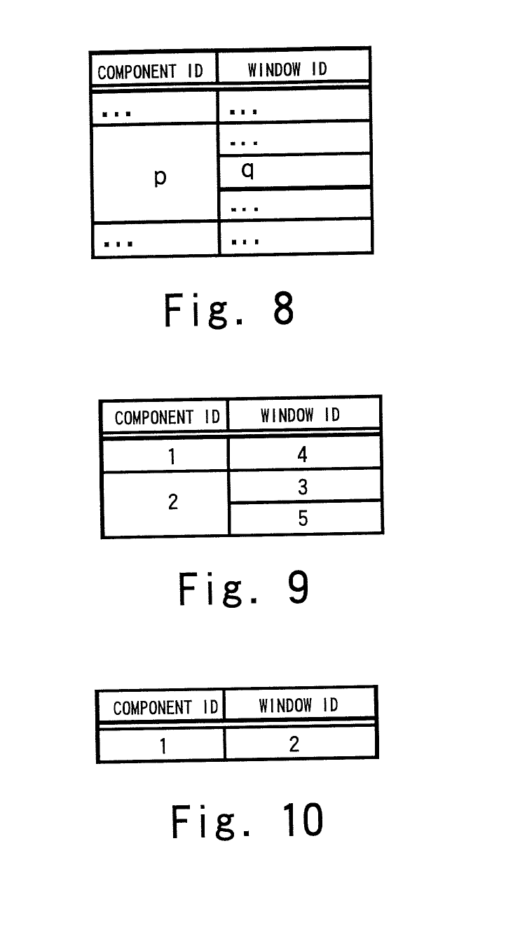

The overlap detector 103 calculates a window overlapping the component detected by the component detector 101 using the locations of the windows and the z-orders detected by the window location detector 104 as the data illustrated in FIG. 5 and the location of the component detected by the component location detector 102 as the data illustrated in FIG. 6, and prepares a data table, which is, for example, as illustrated in FIG. 8 (hereinafter referred to as an overlap table) in a predetermined storage region of the information processor. The example of the overlap table illustrated in FIG. 8 shows that a window with the “window ID=q” and the like overlap a component with the “component ID=p”.

Accordingly, in case two components (with the “component ID=1” and with the “component ID=2”) are detected by the component detector 101, a window with the “window ID=4” overlaps the component with the “component ID=1”, and two windows with the “window ID=3” and with the “window ID=5” overlap the component with the “component ID=2”, the overlap table prepared by the overlap detector 103 is as illustrated in FIG. 9.

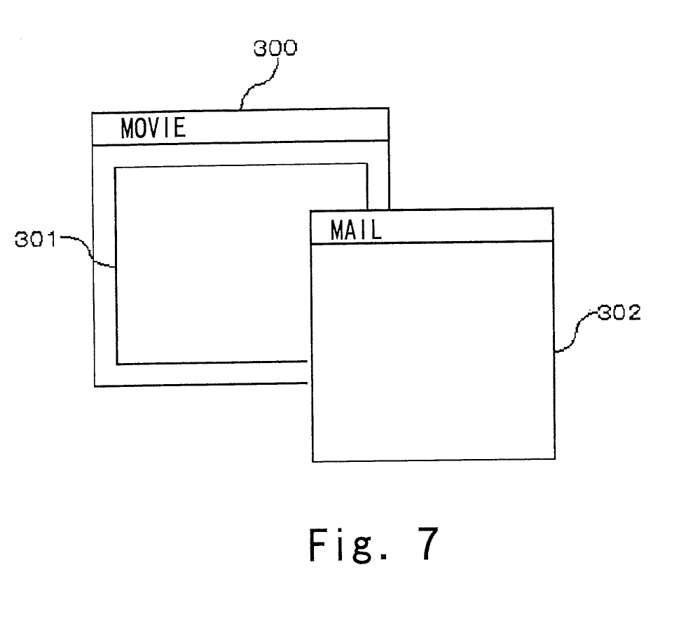

In case the screen displayed on the display is as illustrated in FIG. 7, that is, in case the window 302 overlaps the component 301, the overlap detector 103 prepares an overlap table illustrated in FIG. 10. It is to be noted that the windows 300 and 302 in the screen illustrated in FIG. 7 have the “window ID=1” and the “window ID=2”, respectively, and correspond to the window location table illustrated in FIG. 5, and the component ID of the component 301 is 1 and the component 301 corresponds to the component location table illustrated in FIG. 6.

The visible region determiner 105 refers to the window location table prepared by the window location detector 104, the component location table prepared by the component location detector 102, and the overlap table prepared by the overlap detector 103 to determine a region which is not hidden behind another window, that is, a region which is visible to a user viewing the screen, of the component detected by the component detector 101.

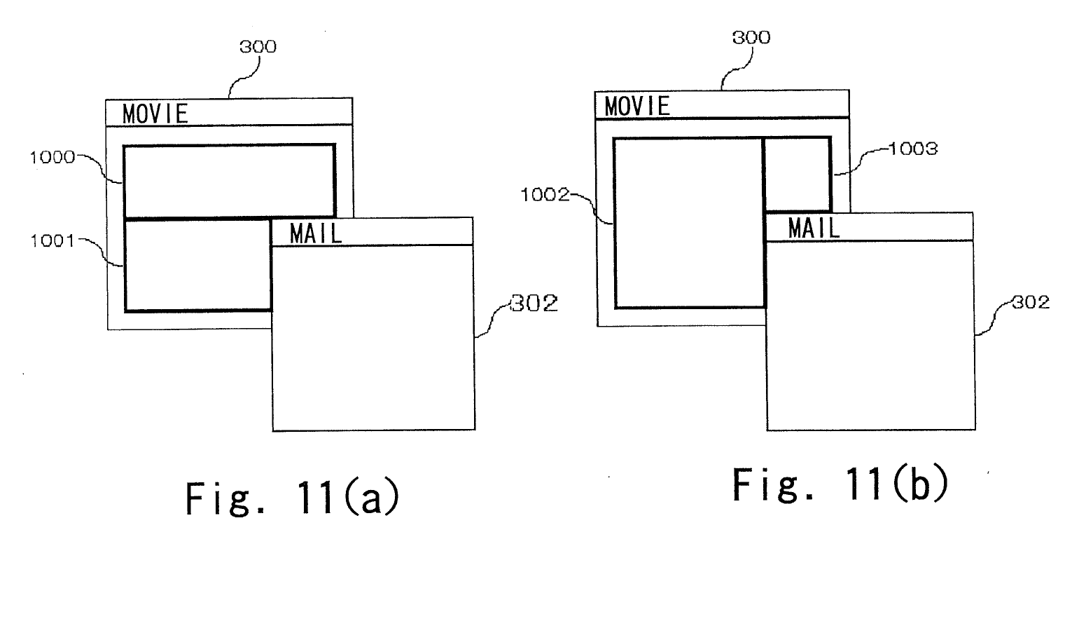

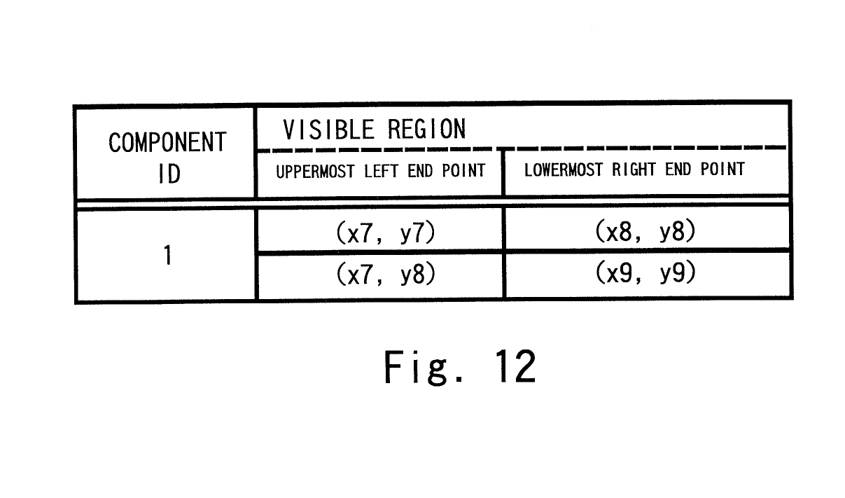

More specifically, when the display on the screen is, for example, as illustrated in FIG. 7, the visible region determinor 105 recognizes the visible region of the component 301 by dividing it with a line segment in parallel with the x-axis as illustrated in FIG. 11(a). Therefore, in this case, the visible region is a region of a rectangle 1000 plus a region of a rectangle 1001. Alternatively, the visible region determiner 105 may recognize the visible region by dividing it with a line segment in parallel with the y-axis as illustrated in FIG. 11(b). In this case, the visible region is a region of a rectangle 1002 plus a region of a rectangle 1003.

The visible region determinor 105 prepares a data table, which is, for example, as illustrated in FIG. 12 (hereinafter referred to as a visible region management table) in a predetermined storage region of the information processor.

Referring to FIG. 12, the visible region of the component with the “component ID=1” (the component 301) is described by coordinate values (x7, y7) of the uppermost left end point and coordinate values (x8, y8) of the lowermost right end point of the rectangle 1000 (1002), and, by coordinate values (x7, y8) of the uppermost left end point and coordinate values (x9, y9) of the lowermost right endpoint of the rectangle 1001 (1003).

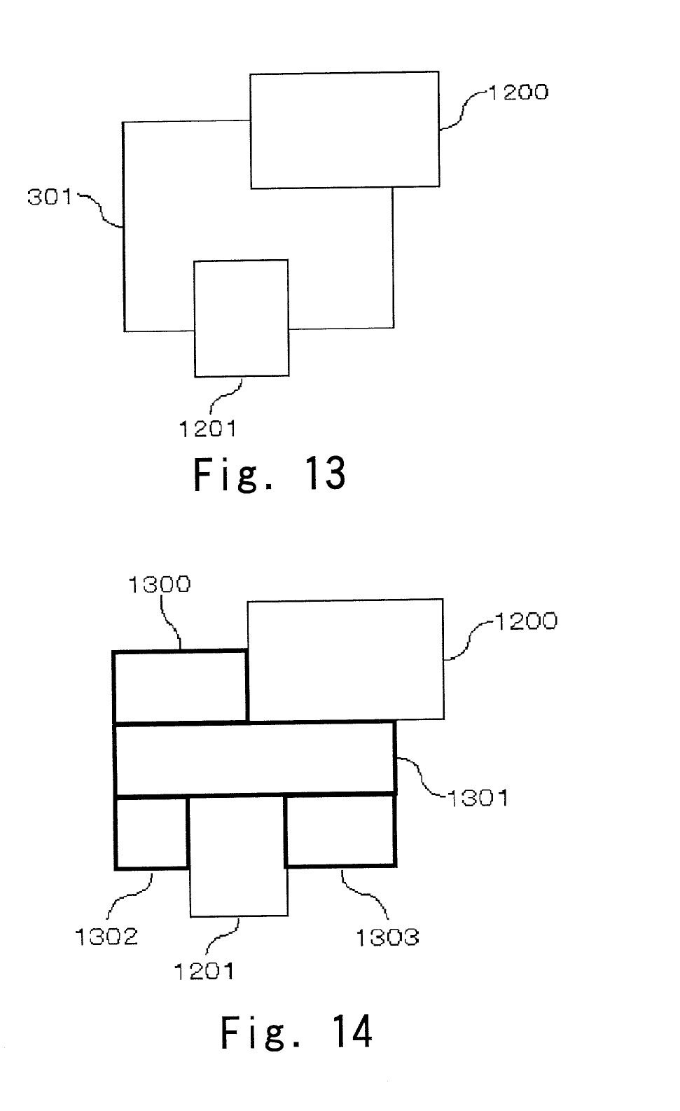

Next, another example of visible region determination by the visible region determination portion 105 is described using FIGS. 13 to 15. Referring to FIG. 13, part of the component 301 detected by the component detection portion 101 is located behind windows (including their title display portions) 1200 and 1201.

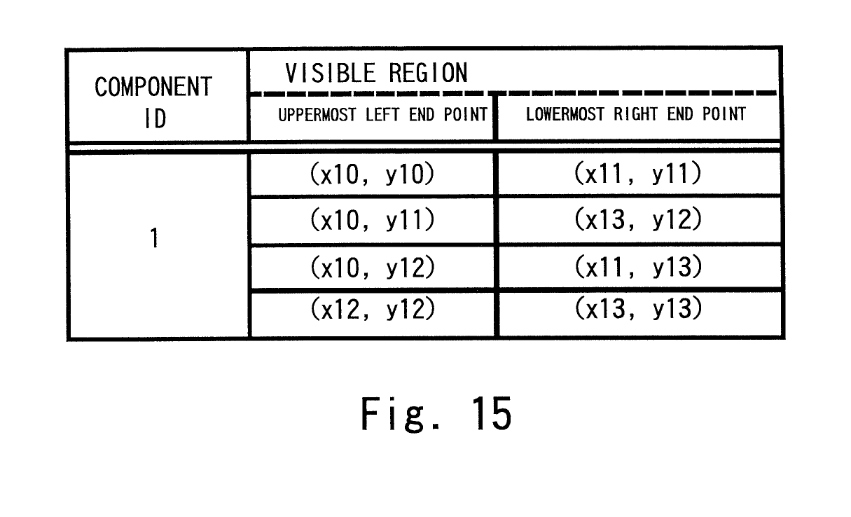

In this case, the visible region determiner 105 recognizes the visible region of the component 301 by dividing it into rectangles 1300 to 1303 as illustrated in FIG. 14, and prepares a visible region table illustrated in FIG. 15. Referring to FIG. 15, the rectangle 1300 is described by coordinate values (x10, y10) of its uppermost left end point and coordinate values (x11, y11) of its lowermost right end point. The rectangle 1301 is described by coordinate values (x10, y11) of its uppermost left endpoint and coordinate values (x13, y12) of its lowermost right end point. The rectangle 1302 is described by coordinate values (x10, y12) of its uppermost left end point and coordinate values (x11, y13) of its lowermost right end point. The rectangle 1303 is described by coordinate values (x12, y12) of its uppermost left endpoint and coordinate values (x13, y13) of its lowermost right end point.

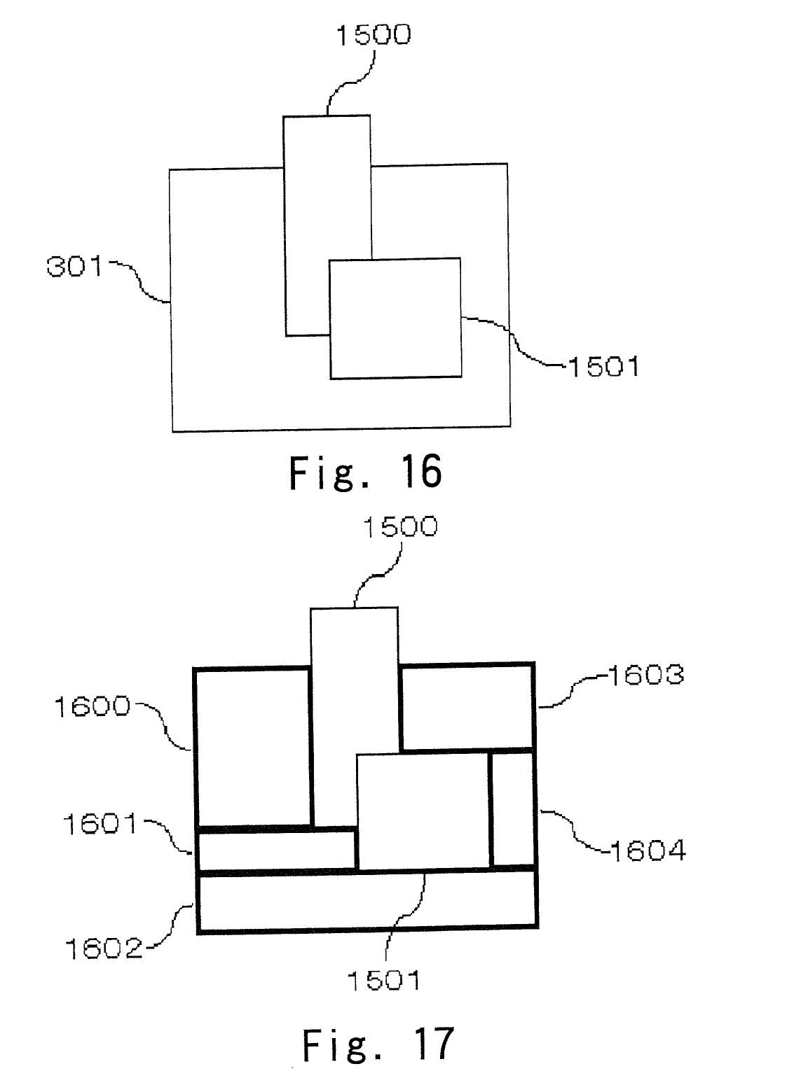

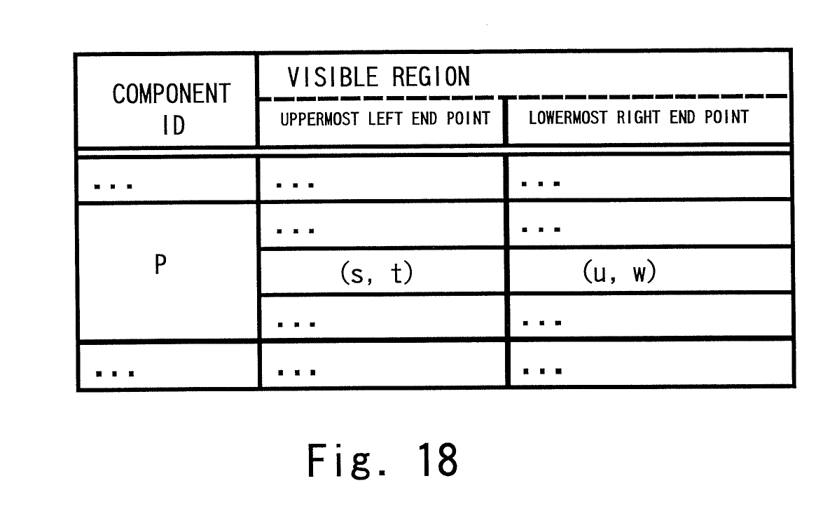

Next, still another example of visible region determination by the visible region determinor 105 is described using FIGS. 16 and 17. Referring to FIG. 16, part of the component 301 detected by the component detector 101 is located behind windows 1500 and 1501.

In this case, the visible region determiner 105 recognizes the visible region of the component 301 by dividing it into rectangles 1600 to 1604 as illustrated in FIG. 17. Then, the visible region determinor 105 prepares a visible region table (not shown).

As described in the above, the visible region table prepared by the visible region determinor 105 is a table as illustrated in FIG. 18. Referring to FIG. 18, it can be seen that the visible region of each component with the “component ID=p” detected by the component detector 101 is described as a rectangle having coordinate values (s, t) as its uppermost left end point and coordinate values (u, w) as its lowermost right end point, or an aggregation of rectangles described in a similar way.

The visible region table manager 106 manages the visible region table prepared by the visible region determiner 105.

The display effector 107 refers to the visible region table managed by the visible region table management portion 106, and applies picture effect processing to picture signals 16 or picture data of the visible region outputted to the display 12 such that the picture becomes more recognizable. Alternatively, the display effector 107 instructs the display 12 to carry out picture effect processing. This picture effect processing is, for example, correction of color or correction of contrast, and processing according to the kind of the display 12 is applied. The display effector 107 may apply the same picture effect to all the visible region rectangles in the visible region table, or alternatively, may selectively apply different picture effect to the respective visible region rectangles based on, for example, instruction from the keyboard 10 or the mouse 11 by a user.

The screen change detector 108 monitors a change of the screen image.

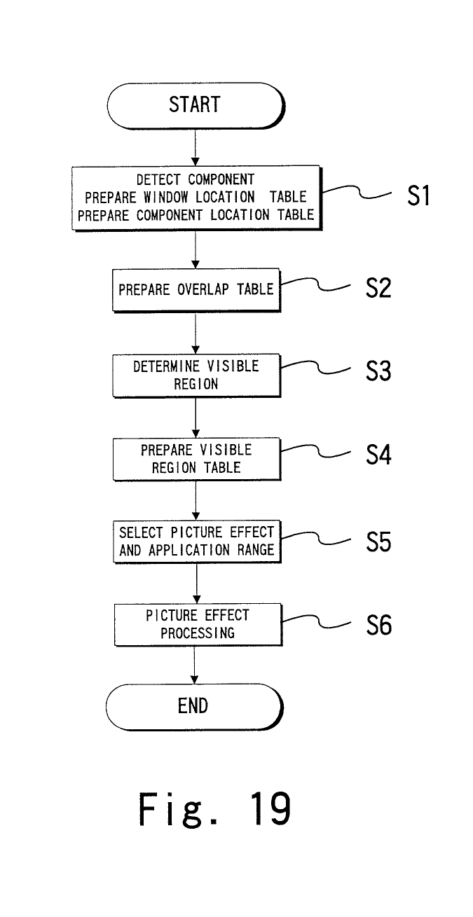

Next, Referring to a flow chart illustrated in FIG. 19, a procedure from detection of a component to application of picture effect to the visible region of the component in this embodiment is described.

First, based on instruction by the screen change detector 108, the component detector 101 detects a component, the component location detector 102 detects the location of the component detected by the component detector 101, the window location detector 104 detects the location and the z-order of a window, and the window location table and the component location table are prepared (step S1). It is to be noted that, as described in the above, the component detected by the component detector 101 is a component registered in advance in the component registrator 100. Further, the component is detected as far as it exists on the screen, and is detected even if it does not have a visible region. In other words, the component is detected even if it is hidden behind windows. The same can be said with regard to detection of a window.

Then, the overlap detector 103 detects the status of overlap of the window with respect to the component detected by the component detector 101 based on the location of the component and the location of the window detected at step S1, and prepares the overlap table (step S2).

Then, the visible region determiner 105 refers to the window location table, the component location table, and the overlap table to determine a region which is visible to a user of the component detected by the component detector 101 (step S3), and prepares the visible region table (step S4).

Then, the user uses the keyboard 10 or the mouse 11 to select picture effect and a visible region application range (a rectangle) to which the picture effect is applied (step S5). Based on the instruction of selection, the display effector 107 carries out picture effect processing with regard to the selected range of the visible region (step S6).

In this way, the region in which a moving picture is displayed (the region where the moving picture is visible to the user) can be specified and the picture effect such as effect of improving the image quality can be applied only to that region.

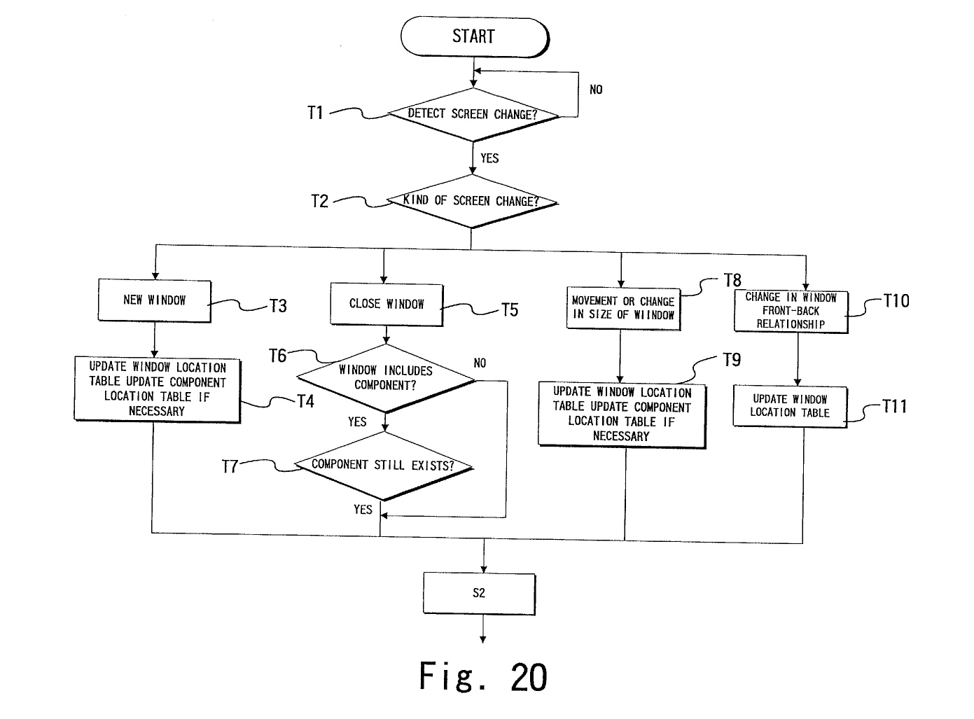

Next, operation of the information processor in case there is a change in the screen, for example, a new window is opened on the screen, is described with reference to a flowchart illustrated in FIG. 20.

The screen change detector 108 in FIG. 2 monitors to see whether there is a change or not in the screen (step T1), and, if there is a change in the screen, determines the kind of the change (step T2).

At step T2, if the screen change detector 108 detects that a new window is opened on the screen (step T3), the screen change detector 108 makes the window location detector 104 detect at least the location of the new window and the z-orders of all the windows opened on the screen, and instructs the window location detector 104 to update the window location table. In addition, the screen change detector 108 makes the component detector 101 detect whether there is a new component or not, and, if there is a new component, makes the component location detector 102 detect the location of the new component and update the component location table (step T4).

After the processing at step T4, the above-described processing at step S2 and the subsequent steps illustrated in FIG. 19 is carried out. However, it is to be noted that, in this case, the selection of the picture effect application range and the selection of the picture effect which have been already specified may be taken over. The same can be said with regard to the following description.

On the other hand, at step T2, if the screen change detector 108 detects that a window on the screen is closed (step T5), the screen change detector 108 makes the window location detector 104 delete the record with regard to the closed window in the window location table, and determines whether the closed window is the window which includes a component by referring, for example, to the component location table (step T6).

As a result of the determination at step T6, if the closed window includes the component, the screen change detector 108 makes the component location detector 102 update the component location table, that is, delete the record with regard to the component included in the closed window, and at the same time, determines whether a component still exists on the screen (step T7).

As a result of the determination at step T6, if the closed window does not include a component, and, as a result of the determination at step T7, if a component still exists on the screen, the above-described processing at step S2 and the subsequent steps illustrated in FIG. 19 is carried out.

At step T2, if the screen change detector 108 detects that a window on the screen has moved or has changed in size (step T8), the screen change detector 108 makes the window location detector 104 update the record registered in the window location table with regard to the window which has moved or has changed in size. If the window which has moved or has changed in size includes a component, the screen change detector 108 makes the component location detector 102 update the record registered in the component location table with regard to the component included in the window which has moved or has changed in size (step T9).

After the processing at step T9, the above-described processing at step S2 and the subsequent steps illustrated in FIG. 19 is carried out.

At step T2, if the screen change detector 108 detects that the front-behind relationship between the windows on the screen has changed (step T10), the screen change detector 108 makes the window location detector 104 update the entries of the z-orders in the window location table, and the processing proceeds to the above-described processing at step S2 and the subsequent steps illustrated in FIG. 19.

In this way, since the screen change detector 108 monitors a change in the screen, even when there is a change in the screen, appropriate picture effect can be applied to a visible region to which picture effect is to be applied as described in the above. It is to be noted that all the processing illustrated in FIG. 19 may be carried out every time the screen change detector 108 detects a change in the screen. Alternatively, the screen change detector 108 may make the above-described processing for changing the tables and the like carried out after there is a change in the screen and after it is detected that there is no further change in the screen within a predetermined time period.

Further, as a function of a general information processor of a multi-window system, there is a function to minimize all the windows on the screen. When, for example, after a user utilizes such a function to minimize all the windows and then restores the original status without opening another window, if the visible region table manager 106 holds the visible region table before the minimization of the windows is carried out, it is not necessary to determine the visible region once again.

In this way, according to the present invention, under a multi-window environment, even if part of a display component is hidden behind another window which overlaps the display component, a region in which a moving picture is displayed (a region where the moving picture is visible to a user of the computer) can be specified, for example, and picture effect such as effect of improving the image quality can be applied only to that region. In other words, the effect of improving the image quality is not exerted on a region which is inside the outer frame of the display component but has no picture displayed therein (a region where another window overlaps).

Therefore, when a user of an information processor having a multi-window environment views moving picture displayed on the display, the user can enjoy recognizable moving picture whether another window overlaps or not.

While this invention has been described in conjunction with the preferred embodiment described above, it will now be possible for those skilled in the art to put this invention into practice in various other manners.

What is claimed is:

1. A display controller comprising:
a first element, which controls a display to display a screen provided with a first screen region on which a particular display component is to be displayed and a second screen region overlapping at least part of said first screen region; and
a second element, which applies display effect to only a screen region of said first screen region without said second screen region overlapped therewith.

2. A display controller as claimed in claim l,wherein said display effect is correction of color or contrast.

3. An information processor comprising:
a detector, which detects a particular display component located within a window on a screen;
a visible region determinor, which determines an actually visible region of a region in which said particular display component detected by said detector is to be displayed; and
a display effector, which applies predetermined display effect to said region detected by said visible region determinor.

4. An information processor as claimed in claim 3, wherein said visible region determiner comprises:
a component location detector, which detects a location on said screen of said particular display component detected by said component detector; and
a window location detector, which detects locations of a plurality of windows on said screen and front-behind relationship between said windows;
wherein said visible region determiner determines said actually visible region of said region in which said particular display component is to be displayed using result of detection by said component location detector and by said window location detector.

5. An information processor as claimed in claim 3, further comprising:
a screen change detector, which detects a change in said screen, when said screen change detector detects a change in said screen, said visible region determinor determines said actually visible region of said region in which said particular display component is to be displayed.

6. An information processor as claimed in claim 3, wherein said display component is a moving picture.

7. An information processor as claimed in claim 3, wherein said display effect is correction of color or contrast.

8. A display control method comprising:
a first step of detecting a particular display component located within a window on a screen;
a second step of determining an actually visible region of a region in which said detected particular display component is to be displayed; and
a third step of applying predetermined display effect to said detected region.

9. A display control method as claimed in claim 8, wherein said display effect is correction of color or contrast.

10. A computer program capable of running on a computer so that the computer performs said steps of claim 8.
